(19) United States
(12) Patent Application Publication
(10) Pub. No.: US 2009/0083530 A1
(43) Pub. Date: Mar. 26, 2009

(54) Computer System, Data Structure Representing Configuration Information, Mapping System, and Mapping Method

(76) Inventors: Osamu Nishijima, Nara (JP); Shirou Yoshioka, Hyogo (JP); Yukihiro Sasagawa, Kyoto (JP); Kenichi Kawaguchi, Hyogo (JP)

Correspondence Address: MCDERMOTT WILL & EMERY LLP, 600 13TH STREET, NW, WASHINGTON, DC, 20005-3096, US

(21) Appl. No.: 11/886,868

(22) PCT Filed: Apr. 4, 2006
(86) PCT No.: PCT/JP2006/307118

§ 371 Date: Sep. 21, 2007

(30) Foreign Application Priority Data
Apr. 5, 2005 (JP) 2005-108386

(51) Int. Cl. G06F 9/00

(52) U.S. Cl. 713/1

(57) ABSTRACT

A configuration information storage section (108) stores configuration information for allowing a reconfigurable module to execute a predetermined function. A CPU (100) configures attached reconfigurable modules (103 to 106) according to the number thereof by referencing the configuration information stored in the configuration information storage section (108).

### TECHNICAL FIELD

The present invention relates to a computer system processing a problem with the use of a reconfigurable module as a constitutional element of which function is capable of being re-configured dynamically, and configuration information for determining a function of the reconfigurable module.

### BACKGROUND ART

As to conventional techniques, there is a computer system to which a reconfigurable logic circuit is connected as an extension system (Patent Document 1). In another one, a predetermined problem is solved at a high speed by mapping the problem to a plurality of FPGAs (Patent Document 2). Moreover, two reconfigurable circuits are connected on a layout at LSI design (Patent Document 3).

Patent Document 1: U.S. Pat. No. 6,438,737
Patent Document 2: U.S. Pat. No. 6,415,430
Patent Document 3: U.S. Pat. No. 6,335,635

### SUMMARY OF THE INVENTION

### Problems that the Invention is to Solve

In a computer system in which a reconfigurable LSI is implemented, when a problem to be processed becomes large-scale, an enormous amount of time is required for the processing with only the implemented configurable LSI. On the other hand, with a large-scale reconfigurable LSI implemented unnecessarily in advance, the cost of the computer system increases as a whole. Namely, the processing time and the cost falls in a tradeoff relationship, and therefore, a system that can be cope therewith flexibly is awaited.

In each of the above conventional techniques, however, configuration information is mapped only after the entire architecture of the computer system is determined at the initial stage, resulting in inflexibility in the tradeoff relationship between the processing time and the cost. For example, in the technique in Patent Document 1, the reconfigurable logic circuit has no extensibility. In the technique Patent Document 2, inherent mapping is performed on a system in which the plurality of FPGAs are arranged, which achieves no problem solving without any one of the plurality of FPGAs. As to the technique in Patent Document 3, the reconfigurable circuits are connected at design merely, so that no additional reconfigurable circuit can be connected and the reconfigurable circuits cannot be cut off after design. As well, the system cannot be composed of a plurality of reconfigurable LSIs, and the number of reconfigurable LSIs cannot be changed.

The present invention has its first object of providing a computer system capable of flexibly coping with, for example, the case where necessity of processing a large-scale problem occurs in future while suppressing initial cost low.

In order to solve a large-scale problem with a reconfigurable circuit, a plurality of reconfigurable LSIs or a large-scale reconfigurable LSI must be implemented. In the conventional techniques, however, mapping of a large-scale problem to hardware is inherent to a computer system to which one or a plurality of configurable LSIs are implemented. For this reason, when the architecture of the hardware is changed, for example, when the circuit size of one implemented reconfigurable LSI becomes large or the number of implemented reconfigurable LSIs is increased, re-mapping is required.

The present invention has its second object of providing configuration information which requires no re-mapping even when the structure of an implemented reconfigurable LSI is changed.

In sum, the object of the present invention is, in solving a large-scale problem by a computer system to which a plurality of reconfigurable modules are implemented, to achieve mapping irrespective of the number of implemented reconfigurable modules and to provide a computer system capable of flexibly coping with the case where a problem becomes large-scale in future.

### Means for Solving the Problems

In view of the foregoing, the present invention achieves extension of a reconfigurable module.

Specifically, a computer system in accordance with an aspect of the present invention includes: a CPU; and a configuration information storage section which stores configuration information for allowing a reconfigurable module to execute a predetermined function, wherein the computer system is so structured that one or more reconfigurable modules are attachable, and the CPU configures an attached reconfigurable module according to number of the attached reconfigurable module by referencing the configuration information stored in the configuration information storage section.

In the above aspect, the reconfigurable modules are attachable. When some of the reconfigurable modules are attached, the CPU configures the attached reconfigurable modules according to the number of the attached reconfigurable modules by referencing the configuration information stored in the configuration information storage section for allowing the reconfigurable modules to execute the predetermined function. Thus, the reconfigurable modules become extensible. Accordingly, the computer system can flexibly cope with the case, for example, where a reconfigurable module is attached when a problem becomes large-scale in future though a less number of reconfigurable modules are provided at the initial stage for reduction in cost.

Another aspect of the present invention provides a data structure for representing configuration information for allowing a reconfigurable module to execute a predetermined function, which includes: plural pieces of sub configuration data respectively corresponding to divided functions into which the predetermined function is divided; and internal structure information indicating a relationship between the plural pieces of sub configuration data and input/output data.

With the above data structure employed, the plural pieces of sub configuration data corresponding to the divided functions into which the predetermined function is divided can be assigned to the reconfigurable module attached to the computer system by referencing the internal structure information indicating the relationship between the plural pieces of sub configuration data and the input/output data. Accordingly, even when the number of reconfigurable modules is changed, the attached reconfigurable modules can be configured optimally by referencing the common configuration information.

Still another aspect of the present invention provides a data structure for representing configuration information for allowing a reconfigurable module to execute a predetermined function, which includes: plural pieces of configuration information corresponding to variations in number of reconfigurable modules, wherein each piece of configuration information includes plural pieces of sub configuration data respectively corresponding to divided functions into which the predetermined function is divided.

In general, configuration information is generated in a system different from a computer system. For this reason, when the number of reconfigurable modules attached to a computer system is changed, the configuration information must be acquired again by any means. In contrast, when the plural pieces of configuration information are prepared correspondingly to variations in the number of configurable modules assumed in advance, like the data structure in the present invention, the change in the number of reconfigurable modules can be coped with flexibly.

Yet another aspect of the present invention provides mapping method and system for generating configuration information for allowing a reconfigurable module to execute a predetermined function, which is to perform: algorithm analysis on the predetermined function to generate a graph expressing a relationship between processing and input/output data; and generation of, by dividing each processing in the graph with a predetermined size set as an upper limit, plural pieces of sub configuration data respectively corresponding to divided functions into which the predetermined function is divided and internal structure information indicating a relationship between the plural pieces of sub configuration data and input/output data.

### EFFECTS OF THE INVENTION

In the present invention, even when the number of reconfigurable modules is changed, the reconfigurable modules can be configured by referencing the same configuration information to execute the necessary processing.

Hence, when a reconfigurable module having increased processing ability is attached, for example, the same function can be executed within a processing time period as ever by a less number of reconfigurable modules.

Further, even when the function to be executed is increased in scale further, extension of a reconfigurable module according to the increase enables execution within a predetermined processing time period. For example, extension of a reconfigurable module to a system that performs only video replay enables simultaneous operation of replaying the video and recording while converting the received video from HD to SD.

### BRIEF DESCRIPTION OF THE DRAWINGS

FIG. 1 is a diagram showing an architecture of a computer system in accordance with one embodiment of the present invention.

FIG. 2 shows a structural example of an attachable mechanism for a reconfigurable LSI.

FIG. 3 is a diagram showing an architecture of the computer system to which reconfigurable LSIs, of which number is different from that in FIG. 1, is implemented.

FIG. 4 is a diagram showing a construction of a mapping system in accordance with one embodiment of the present invention.

FIG. 5 is a drawing showing one example of the processing of format conversion of a video from HD to SD.

FIG. 6 is a diagram showing an example indicating a processing result of an algorithm analyzing section in the mapping system of FIG. 4.

FIG. 7 is a diagram showing a processing result of a configuration information generating section in the mapping system of FIG. 4.

FIG. 8 presents diagrams showing an example of a processing result of a number providing section in the mapping system of FIG. 4.

FIG. 9 is a diagram showing an example of a processing result of a communication information providing section in the mapping system of FIG. 4 and showing one example of configuration information in accordance with the present invention.

FIG. 10 is a schematic diagram showing a state where the configuration information in FIG. 9 is stored.

FIG. 11 is a diagram showing an example of mapping of a communication memory.

FIG. 12 is a flowchart depicting an operation of a computer system in accordance with one embodiment of the present invention.

FIG. 13 presents diagrams specifically showing an operation of the computer system of FIG. 1.

FIG. 14 presents diagrams specifically showing an operation of the computer system of FIG. 3.

FIG. 15 presents diagrams specifically showing an operation in the case where two reconfigurable LSIs are replaced by one reconfigurable LSI having an integration twice as large as each of the two configurable LSIs in the computer system of FIG. 3.

FIG. 16 is a diagram showing another example of the configuration information in accordance with the present invention.

FIG. 17 is a schematic diagram showing a state where the configuration information of FIG. 16 is stored.

FIG. 18 is a diagram showing another example of a processing result of the configuration information generating section in the mapping system of FIG. 4.

FIG. 19 is a diagram showing another example of the architecture of the computer system in accordance with the present invention.

FIG. 20 is a diagram showing another example of the architecture of the computer system in accordance with the present invention.

FIG. 21 is a diagram showing still another example of the architecture of the computer system in accordance with the present invention.

FIG. 22 is a diagram showing yet another example of the architecture of the computer system in accordance with the present invention.

FIG. 23 is a diagram showing still another example of the architecture of the computer system in accordance with the present invention.

FIG. 24 is diagram showing an example of the configuration information in the architecture of FIG. 23.

FIG. 25 shows another example of the architecture of the computer system in accordance with the present invention.

FIG. 26 shows still another example of the architecture of the computer system in accordance with the present invention.

FIG. 27 shows yet another example of the architecture of the computer system in accordance with the present invention.

FIG. 28 is a diagram showing an example of the configuration information in the architecture of FIG. 26 or FIG. 27.

### EXPLANATION OF REFERENCE NUMERALS

100 CPU
101 main memory
102 bus bridge
103, 104, 105, and 106 reconfigurable LSI (reconfigurable module)
107 communication memory
108 configuration information storage memory (configuration information storage section)
110 main bus
111 communication bus
120 communication bus
121 socket (joint part)
122 reconfigurable LSI
200 algorithm analyzing section
201 configuration information generating section
202 number providing section
203 communication information providing section
300 configuration sequence determination information
301 internal structure information
302 implementation sequence information
400 configuration sequence determination information
401 internal structure information
402 dependence information
404 to 410 sub configuration data

### BEST MODES FOR CARRYING OUT THE INVENTION

The best modes for carrying out the present invention will be described below with reference to the accompanying drawings.

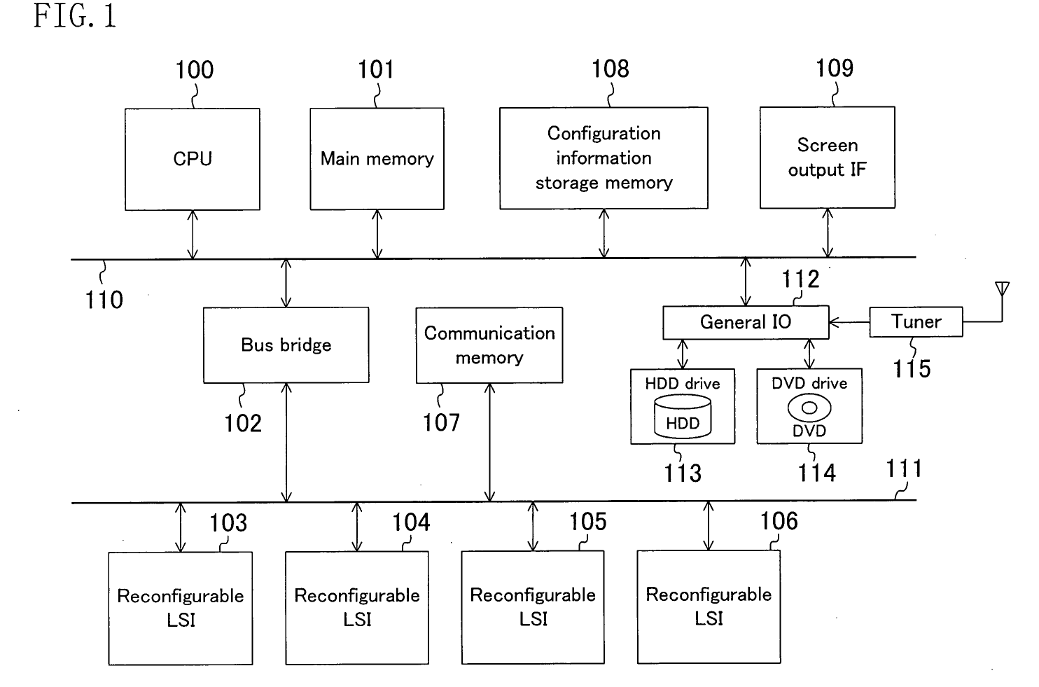

FIG. 1 is a diagram showing an architecture of a computer system in accordance with one embodiment of the present invention. In FIG. 1, a CPU 100 as a processor unit reads out a program stored in a main memory 101 via a main bus 110 and operates according to the program, thereby controlling the entire computer system. The main bus 110 is connected to a communication bus 111 through a bus bridge 102. The bus bridge 102 has a function of adjusting the master/slave relationship between devices connected to the main bus 110 or the communication bus 111 in data interchange.

A configuration information storage memory 108 as a configuration information storage section, a screen output interface (IF) 109, and a general IO 112 are connected to the main bus 110. The computer system can perform data interchange with a HDD drive 113, a DVD drive 114, a tuner 115, and the like via the general IO 12.

Reconfigurable LSIs 103 to 106 as devices of which functions are reconfigurable and a communication memory 107 are connected to the communication bus 111. The reconfigurable LSIs 103 to 106 perform communication with one another via the communication memory 107.

The reconfigurable LSIs 103 to 106 are attachable to the computer system shown in FIG. 1 and function as reconfigurable modules.

The configuration information storage memory 108 stores configuration information for allowing each reconfigurable module to execute a predetermined function. Upon determination of the internal connection of each reconfiguration modules 103 to 106 according to the configuration information stored in the configuration information storage memory 108, the functions of the reconfigurable modules 103 to 106 become configurable. In other words, the configuration information is information used for determining the internal connections of the reconfigurable LSIs in order to allow each reconfigurable LSI as a reconfigurable device to execute a predetermined function. The CPU 100 configures attached reconfigurable modules according to the number of the attached reconfigurable modules by referencing the configuration information stored in the configuration information storage memory 108.

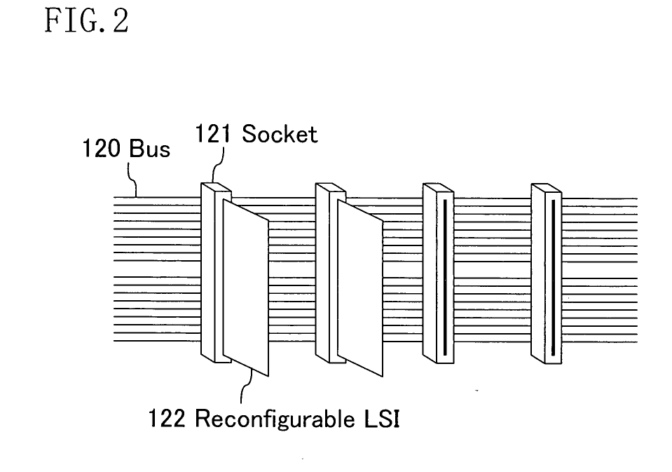

FIG. 2 shows a structural example of an attachable mechanism for a reconfigurable LSI. The structure shown in FIG. 2 includes four sockets 121 as joint parts connected to the communication bus 120 on a board, wherein a reconfigurable LSI 122 is attachable to each socket 121. The structures of the sockets 121 and the communication bus 120 can be attained in the same manner as that to connect a memory to a personal computer, for example. In the example shown in FIG. 2, two reconfigurable LSIs 122 are implemented while two sockets 121 are opened, wherein the number of reconfigurable LSIs capable of being implemented is four to the maximum.

Provision of the mechanism shown in FIG. 2 in a computer system enables change in the number of reconfigurable LSIs to be implemented. For example, in the computer system shown in FIG. 1, a plurality of sockets 121 shown in FIG. 2 are provided at the communication bus 111.

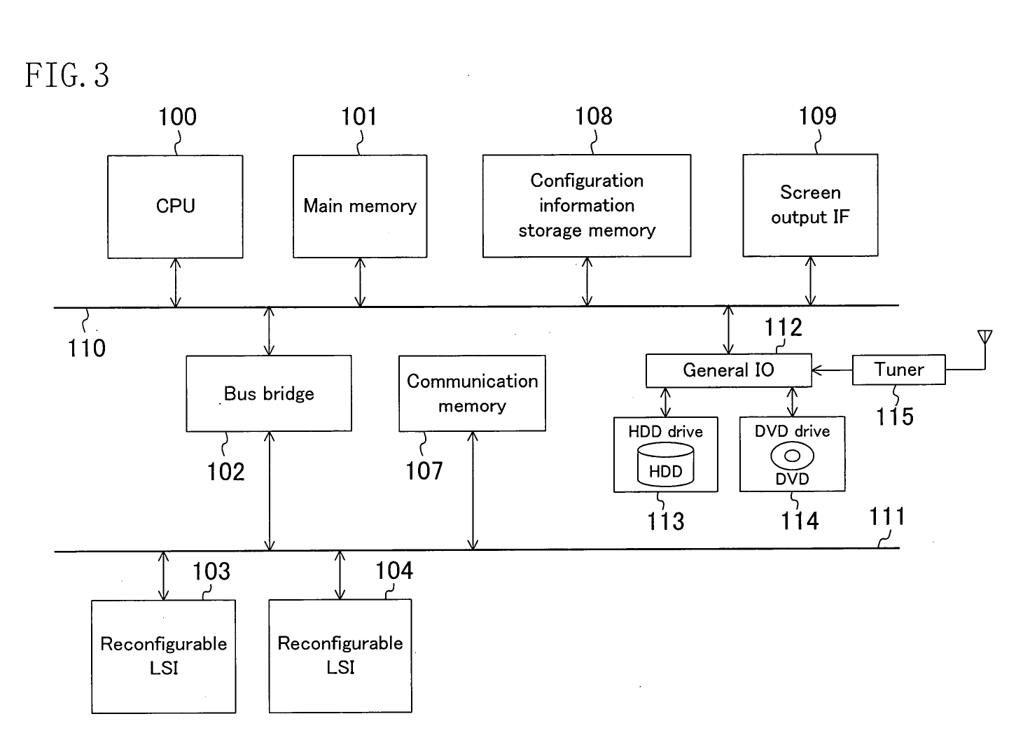

FIG. 3 shows an architecture of the computer system in the case where two reconfigurable LSIs 103, 104, of which number which is different from that in FIG. 1, are implemented.

The following description assumes that the reconfigurable LSIs 103 to 106 have the same circuit size.

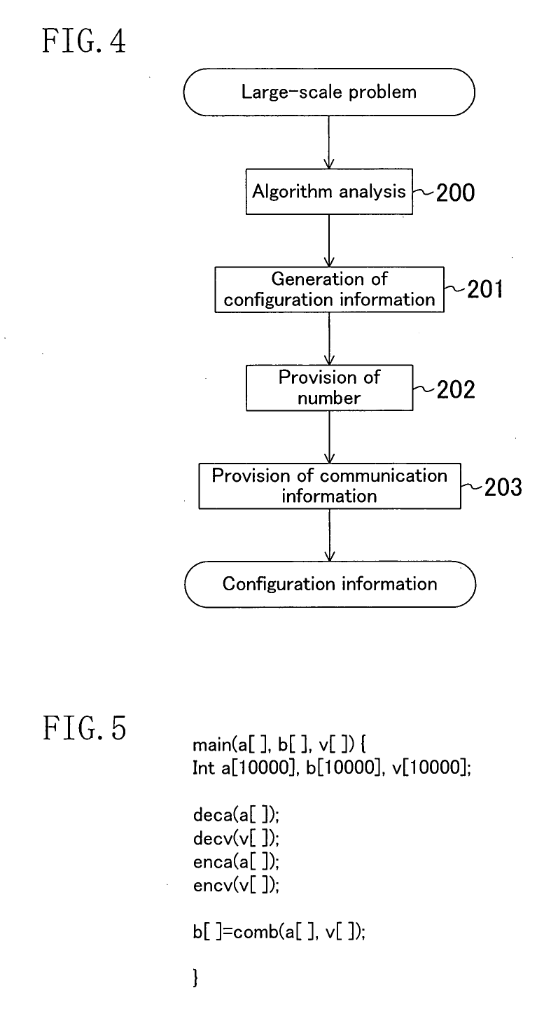

FIG. 4 is a diagram showing a construction of a mapping system in accordance with one embodiment of the present invention. The mapping system of FIG. 4 determines how a large-scale problem to be processed in the computer system as shown in FIG. 1 is assigned to the respective reconfigurable LSIs of the computer system, which is called mapping in the present specification. Namely, the mapping system of FIG. 4 generates configuration information for allowing each reconfigurable module to execute a predetermined function.

To the mapping system of FIG. 4, a large-scale problem to be processed in the computer system is input first. The problem herein means a target that the computer system is to processed, such as encoding/decoding of MPEG, cryptanalysis, or the like, namely, a predetermined function that the computer system is to perform.

The input large-scale problem is developed into a graph composed of a plurality of stages and connection branches in an algorithm analyzing section 200 first. Then, the plurality of developed stages are converted into plural pieces of sub configuration data each having an upper limit of its data amount in a configuration information generating section 201. The numbers are provided to the plural pieces of converted sub configuration data in a number providing section 202. Then in a communication information providing section 203, communication information between the reconfigurable modules configured according to the sub configuration data is provided to the configuration information.

When it is supposed that the reference numerals 200 to 203 in FIG. 4 are processing steps, FIG. 4 serves as a flowchart depicting a mapping method for generating configuration information for allowing reconfigurable modules to execute a predetermined function in accordance with one embodiment of the present invention.

The specific processing of the mapping system of FIG. 4 will be described further in detail with reference to FIG. 5 to FIG. 9. As one example of a large-scale problem, processing for format conversion of a video from HD (High Definition) to SD (Standard Definition) will be referred to in the following description.

FIG. 5 indicates an example of the processing for format conversion of a video from HD to SD. In FIG. 5, deca indicates a function for decoding audio data, decv indicates a function for decoding video data, enca indicates a function for encoding audio data, and encv indicates a function for encoding video data. As well, comb indicates a function for generating stream data from video data generated with encv and audio data generated with enca.

In the present embodiment, the reconfigurable LSIs 103 to 106 are attachable. Namely, the architecture of the computer system is not fixed in advance and is changeable in contrast to that of the conventional one. On the other hand, a mapping system is structured as a separate system from a computer system in general, and therefore, it is difficult to perform re-mapping every time the architecture of the computer system is changed. For this reason, it is important how to generate, when the architecture of the computer system is changed, configuration information for reconstruction of the system without necessitating re-mapping.

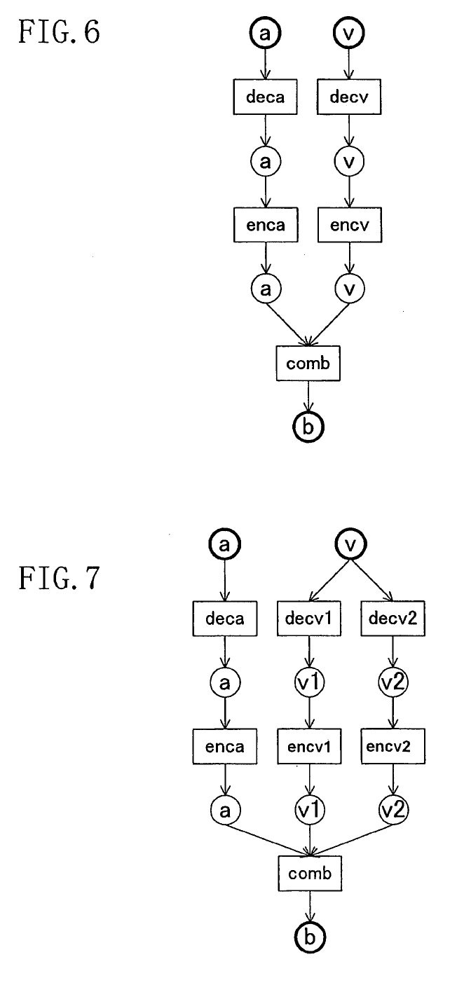

FIG. 6 shows an example of a processing result of the algorithm analyzing section 200 in the mapping system of FIG. 4. In FIG. 6, algorithm analysis is performed on the processing of FIG. 5 as the predetermined function. As shown in FIG. 6, a graph showing the relationship between the processing and input/output data is generated. In detail, the input/output data are enclosed by circles while the processing are enclosed by boxes. The data streams are indicated by arrow-like connection branches.

As shown in FIG. 6, enca uses the processing result of deca while encv uses the processing result of decv. Further, comb uses both the processing results of enca and encv. While, there is no dependence between deca and decv and between enca and encv, and therefore, each pair can be executed in parallel with each other.

In general, video processing has a larger processing amount than audio processing. Accordingly, in this example, each of decv and encv is too large-scale to be mapped to one reconfigurable LSI.

FIG. 7 is a diagram showing an example of a processing result of the configuration information generating section 201 in the mapping system of FIG. 4. In FIG. 7, each processing in the graph of FIG. 6 has a predetermined size as an upper limit as a result of division. In FIG. 7, input/output data are enclosed by circles while sub configuration data are enclosed by boxes. The data streams are indicated by arrow-like connection branches.

Herein, the sub configuration data means data for configuring a configurable module in the configuration information for configuring the entire computer system.

Further, the predetermined size means, specifically, a scale of processing capable of being mapped to each reconfigurable LSI 103 to 106. The predetermined size is determined from the specification of to-be-attached reconfigurable modules. For example, the data size to the extent that data can be mapped to a reconfigurable module having a minimum circuit size is set as the predetermined size. When sub configuration data is set so as not to have a size larger than the predetermined size, the generated sub configuration data necessarily has a size that enables configuration of one reconfigurable LSI.

FIG. 7 is different from FIG. 6 in that decv and encv are divided into decv1 and decv2 and encv1 and encv2, respectively. As described above, each of decv and encv is large-scale and accordingly is divided into two as a result of setting of the predetermined size as an upper limit. Division is performed by analyzing each algorithm of the processing and dividing the analyzed algorithms into sub algorithms capable of being processed in parallel with each other.

Each of the algorithm and the divided sub algorithms is converted into sub configuration data as information for determining the internal connection of a corresponding reconfigurable LSI, so that plural pieces of sub configuration data corresponding to the divided functions into which the predetermined function is divided are acquired. Further, internal construction information is acquired which indicates the relationship between the sub configuration data and the input/output data, as shown in FIG. 7. Namely, the boxes in FIG. 6 represent the processing vaguely while the boxes in FIG. 7 represent the sub configuration data for configuring the respective reconfigurable LSIs.

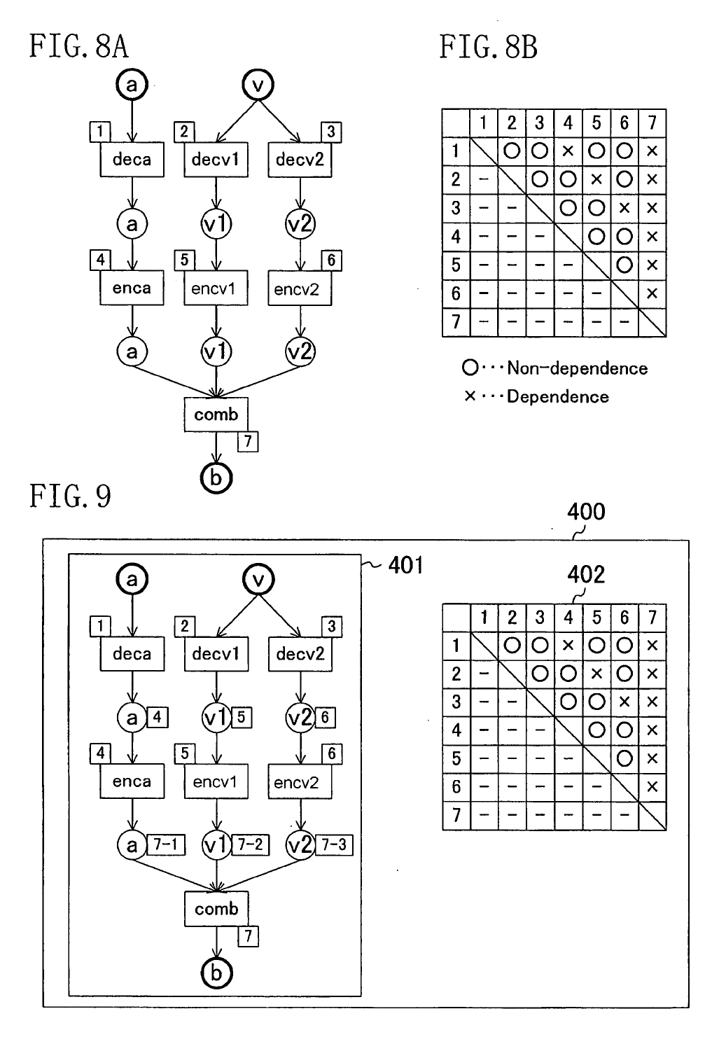

FIG. 8 presents diagrams showing an example of a processing result of the number providing section 202 in the mapping system of FIG. 4. In FIG. 8(a), each sub configuration data is provided with serial numbers in the internal structure information of FIG. 7. In other words, the a serial number enclosed by boxes are provided at the shoulders of the sub configuration data enclosed by boxes. Further, as shown in FIG. 8(b), dependence information indicating dependence between the sub configuration data is generated. In the table data in FIG. 8(b), the numerals are the serial numbers provided to the sub configuration data white ∘ and X indicate non-dependence and dependence. Namely, ∘ means that the sub configuration data are capable of being mapped to different configurable LSIs at the same timing while X means that one of sub configuration data to which a large number is provided is capable of being mapped only after the processing of the sub configuration data to which a small number is provided is completed.

FIG. 9 is a diagram showing an example of a processing result of the communication information providing section 203 in the mapping system of FIG. 4. In FIG. 9, numbers are provided to respective pieces of intermediate data in the middle of the processing in the internal structure information in FIG. 8. Specifically, the numbers enclosed by boxes are assigned at the shoulders of the respective pieces of intermediate data. The numbers are serial numbers for data to be put into the communication memory in communication between reconfigurable modules. In this state, the configuration information for configuring the computer system is completed. Then, configuration sequence determination information 400 including the internal structure information 401 and the dependence information 402 and the configuration information composed of the plural pieces of sub configuration data are stored into the configuration information storage memory 108 in FIG. 1.

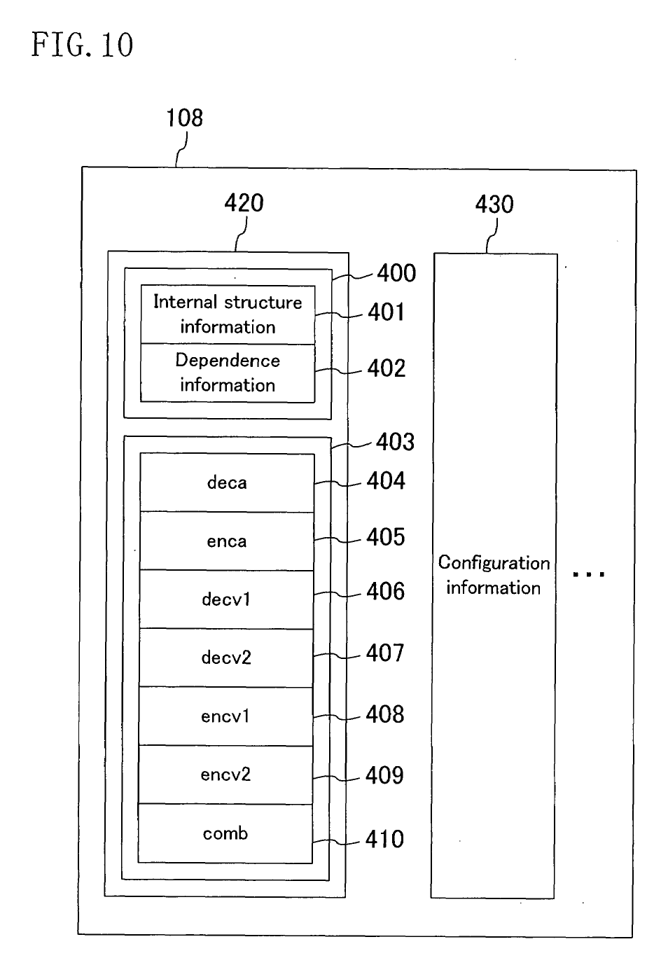

FIG. 10 is a schematic diagram showing the state where the configuration information is stored in the configuration information storage memory 108. In FIG. 10, reference numeral 400 denotes the configuration sequence determination information including the internal structure information 401 and the dependence information 402, and 403 denotes a sub configuration data module having plural pieces of sub configuration data 404 to 410. The configuration sequence determination information 400 and the sub configuration data module 403 compose the configuration information 420. Configuration information 430 for attaining another function is also stored in the configuration information storage memory 108. The configuration information is implemented in the configuration information storage memory 108 in advance, for example. Alternatively, the configuration information may be recorded in a computer-readable recording medium, such as a DVD in advance so as to be read out and be installed in the configuration information storage memory 108 via the general IO 112.

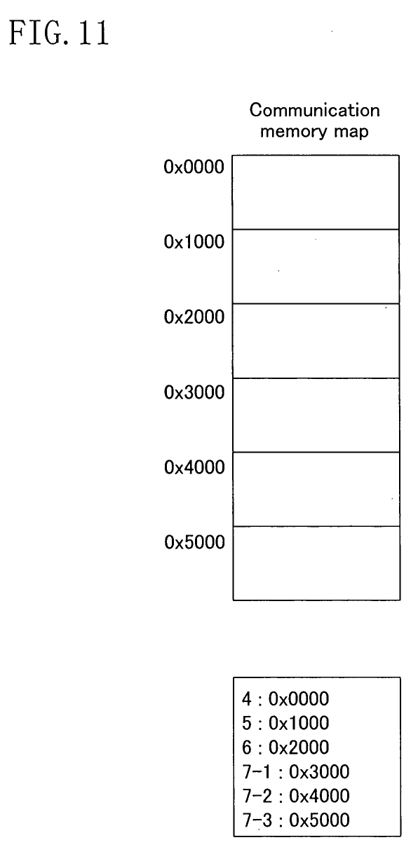

FIG. 11 shows an example of mapping to the communication memory 107 in FIG. 1. In FIG. 11, the respective pieces of intermediate data to which the numbers are provided in FIG. 9 are mapped. A cross-reference between the intermediate data and memory addresses is given at a lower address for being used for communication in operation.

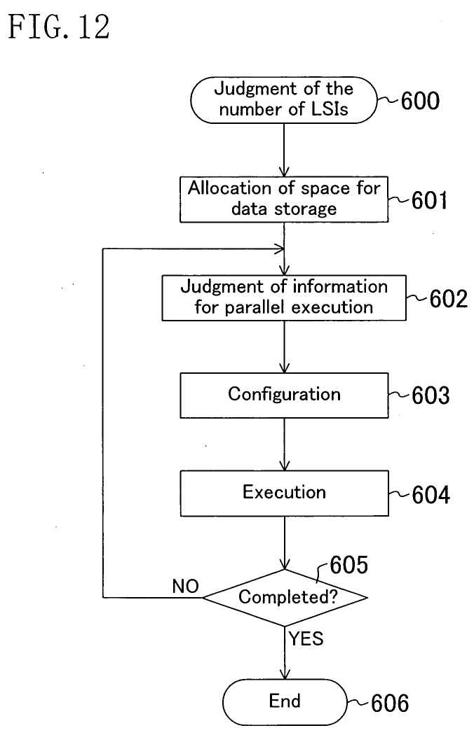

FIG. 12 is a flowchart depicting an operation of the computer system in accordance with the present embodiment. As depicted in FIG. 12, the CPU 100 first judges the number of attached reconfigurable LSIs (600). Then, space for data storage is allocated in the main memory 101 and the communication memory 107 by referencing the internal structure information 401 in the configuration information stored in the configuration information storage memory 108 (601).

Next, the CPU 100 references the internal structure information 401 and the dependence information 402 of the configuration information stored in the configuration information storage memory 108 to determine sub configuration data to be executed in parallel with each other according to the number of the attached reconfigurable LSIs (602). Then, the reconfigurable LSIs are configured with the use of the sub configuration data (603), and each reconfigurable LSIs is allowed to execute the processing (604). The above steps 602 to 603 are repeated until configuration and processing of all of the sub configuration data are executed (605). When the configuration and processing of all of the sub confirmation data are executed, the operation is terminated (606).

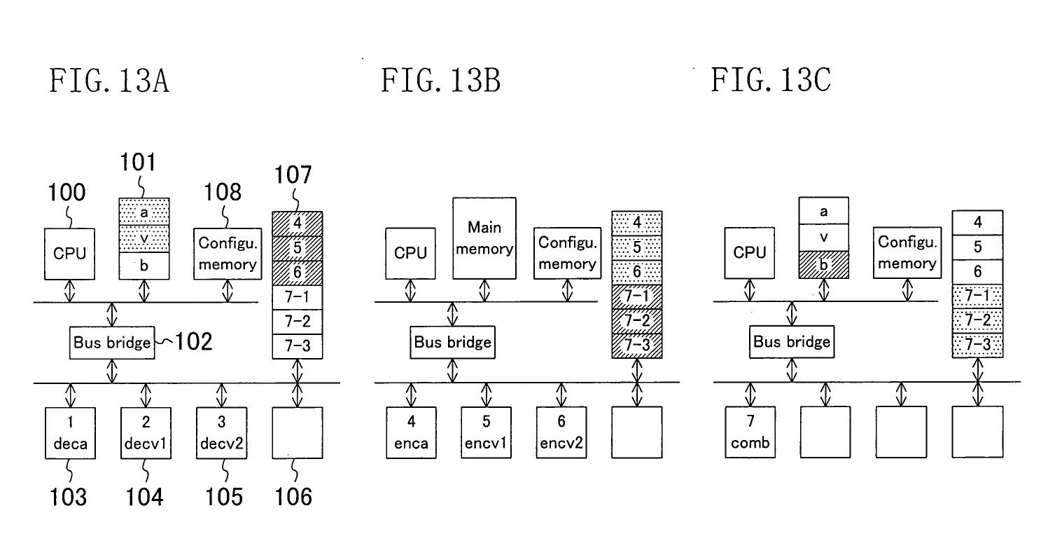

Concrete description will be given to the operation of the computer system of FIG. 1 with reference to FIG. 13. Suppose herein that the configuration information shown in FIG. 9 is stored in the configuration information storage memory 108. The CPU 100 first judges the number of attached reconfigurable LSIs 103 to 106 as four (600). Then, as shown in FIG. 13(a), space where input data a, v and output data b are to be stored is allocated in the main memory 101 while space where the intermediate data with the numbers 4, 5, 6, 7-1, 7-2, and 7-3 are to be stored are allocated in the communication memory 107 (601).

Next, the CPU 100 assigns the sub configurable data to the reconfigurable LSIs 103 to 106 to allow them to execute the processing. Herein, on the basis of the fact that the number of the attached reconfigurable LSIs is four, configuration is executed three times by referencing the internal structure information 401 and the dependence information 402 stored in the configuration information storage memory 108.

First, as shown in FIG. 13(a), the CPU 100 judges the sub configuration data with the numbers 1, 2, and 3, namely, deca, decv1, and decv2 to be executed in parallel with one another (602) and configures the reconfigurable LSIs 103 to 105 with the use of the sub configuration data (603). Then, the CPU 100 allows the reconfigurable LSIs 103 to 105 to execute the processing (604). In so doing, the input data a, v stored in the main memory 101 are input into the reconfigurable LSIs 103 to 105 via the bus bridge 102, and the intermediate data with the numbers 4, 5, and 6 obtained as a result of the processing are stored into the communication memory 107.

Next, as shown in FIG. 13(b), the CPU 100 judges that the sub configuration data with the numbers 4, 5, and 6, namely, enca, encv1, and encv2 are to be executed in parallel with on another (602) and configures the reconfigurable LSIs 103 to 105 with the use of the sub configuration data (603). Then, the reconfigurable LSIs 103 to 105 are allowed to execute the processing (604). In so doing, the intermediate data with the numbers 4, 5, and 6 stored in the communication memory 107 are input into the reconfigurable LSIs 103 to 105, and the intermediate data with the numbers 7-1, 7-2, and 7-3 obtained as a result of the processing are stored into the communication memory 107.

Subsequently, as shown in FIG. 13(c), the CPU 100 judges that the sub configuration data with the number 7, namely, comb is to be executed (602), configures the reconfigurable LSI 103 with the use of the sub configuration data (603), and then, allows the reconfigurable LSI 103 to execute the processing (604). In so doing, the intermediate data with the numbers 7-1, 7-2, and 7-3 stored in the communication memory 107 are input into the reconfigurable LSI 103, and the output data b obtained as a result of the processing is stored into the main memory 101 via the bus bridge 102. Thus, all the processing is completed, thereby terminating the operation (605 and 606).

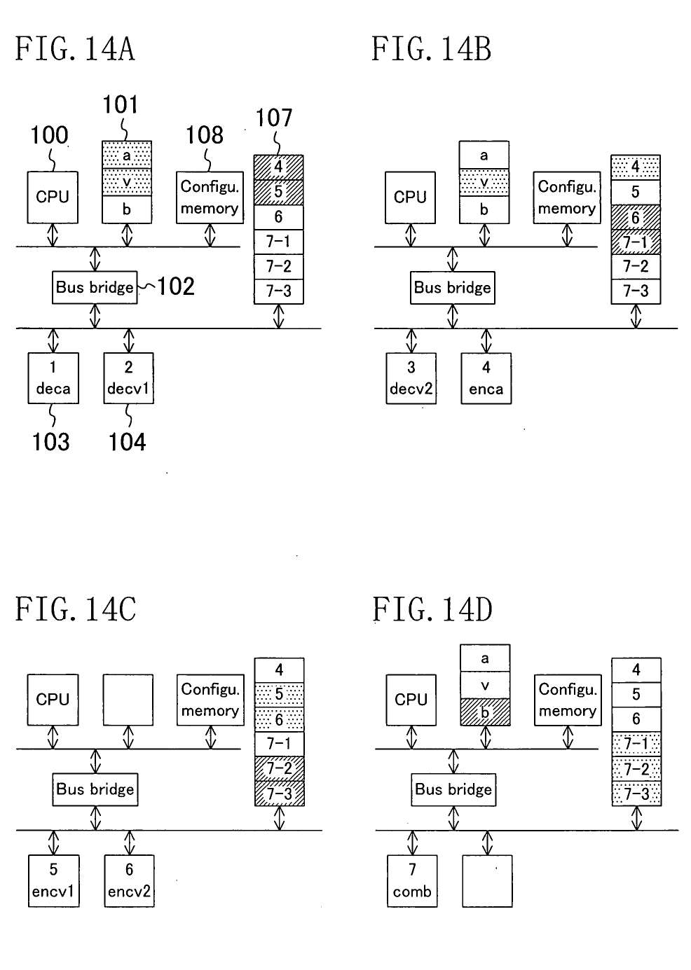

As well, concrete description will be given to the operation of the computer system of FIG. 3 with reference to FIG. 14. Suppose herein that the configuration information shown in FIG. 9 is stored in the configuration information storage memory 108. The CPU 100 first judges the number of attached reconfigurable LSIs 103, 104 as two (600). Then, as shown in FIG. 14(a), the space where the input data a, v and the output data b are to be stored is allocated in the main memory 101 while the space where the intermediate data with the numbers 4, 5, 6, 7-1, 7-2, and 7-3 are to be stored are allocated in the communication memory 107 (601).

Next, the CPU 100 assigns the sub configuration data to the reconfigurable LSIs 103, 104 to allow them to execute the processing. Herein, on the basis of the fact that the number of the attached reconfigurable LSIs is two, configuration is executed four times by referencing the internal structure information 401 and the dependence information 402 stored in the configuration information storage memory 108.

First, as shown in FIG. 14(a), the CPU 100 judges the sub configuration data with the numbers 1 and 2, namely, deca and decv1 to be executed in parallel with each other (602) and configures the reconfigurable LSIs 103 and 104 with the use of the sub configuration data (630). Then, the CPU 100 allows the reconfigurable LSIs 103 and 104 to execute the processing (604). In so doing, the input data a, v stored in the main memory 101 is input into the reconfigurable LSIs 103 and 104 via the bus bridge 102, and the intermediate data with the numbers 4 and 5 obtained as a result of the processing are stored into the communication memory 107.

Next, as shown in FIG. 14(b), the CPU 100 judges that the sub configuration data with the numbers 3 and 4, namely, decv2 and enca to be executed in parallel with each other (602) and configures the reconfigurable LSIs 103, 104 with the use of the sub configuration data (603). Then, the reconfigurable LSIs 103, 104 are allowed to execute the processing (604). In so doing, the input data v stored in the main memory 101 is input into the reconfigurable LSI 103 via the bus bridge 102, the intermediate data with the number 4 stored in the communication memory 107 is input into the reconfigurable LSI 104, and the intermediate data with the numbers 6 and 7-1 obtained as a result of the processing are stored into the communication memory 107.

Subsequently, as shown in FIG. 14(c), the CPU 100 judges the sub configuration data with the numbers 5 and 6, namely, encv1 and encv2 to be executed in parallel with each other (602), configures the reconfigurable LSIs 103, 104 with the use of the sub configuration data (603), and then, allows the reconfigurable LSIs 103, 104 to execute the processing (604). In so doing, the intermediate data with the numbers 5 and 6 stored in the communication memory 107 are input into the reconfigurable LSIs 103, 104, and the intermediate data with the numbers 7-2 and 7-3 obtained as a result of the processing are stored into the communication memory 107.

Thereafter, as shown in FIG. 14(d), the CPU 100 judges the sub configuration data with the number 7, namely, comb to be executed (602), configures the reconfigurable LSI 103 with the use of the sub configuration data (603), and then, allows the reconfigurable LSI 103 to execute the processing (604). In so doing, the intermediate data with the numbers 7-1, 7-2, and 7-3 stored in the communication memory 107 are input into the reconfigurable LSI 103, and the output data b obtained as a result of the processing is stored into the main memory 101 via the bus bridge 102. Thus, all the processing is completed, thereby terminating the operation (605 and 606).

In contrast to the processing divided by three in FIG. 13 in the computer system to which four reconfigurable LSIs are attached as shown in FIG. 1, the processing is divided by four in the computer system to which two reconfigurable LSIs are attached as shown in FIG. 3. Accordingly, according to the present embodiment, even if the number of attached reconfigurable LSIs becomes different, the computer system can be configured by referencing the same configuration information. Hence, it becomes possible that the processing is executed with the use of a less number of reconfigurable LSIs initially and is executed at high speed by attaching a reconfigurable LSI thereafter.

It is noted that in the case where the processing ability of each reconfigurable LSI in FIG. 3 is higher than that of each reconfigurable LSI in FIG. 1, the same processing as that shown in FIG. 13 may be able to be executed.

Further, if the processing shown in FIG. 14 takes much time, a reconfigurable LSI may be attached to attain the architecture shown in FIG. 1 for achieving higher processing ability.

The processing shown in FIG. 13 does not uses the reconfigurable LSI 106. When the reconfigurable LSI 106 is used, another piece of processing can be executed in parallel with the processing shown in FIG. 13. In FIG. 13, the processing for recording a video is executed. With the use of the reconfigurable LSI 106, a TV program can be watched while the video is recorded, for example.

The description heretofore supposes that the reconfigurable LSIs to be attached are all the same in circuit size. It is needless to say, however, that the reconfigurable LSIs to be attached may be different from each other in circuit size. With such a case taken into consideration, it is preferable to include information on size of each sub configuration data in the configuration information. Specifically, information (hereinafter referred to as size information) indicating the circuit size of each reconfigurable LSI that can be configured with the use of the sub configuration data is stored in the configuration information storage memory 108. This permits the computer system to cope flexibly with, for example, replacement of a currently attached reconfigurable LSI by a further highly integrated reconfigurable LSI in future.

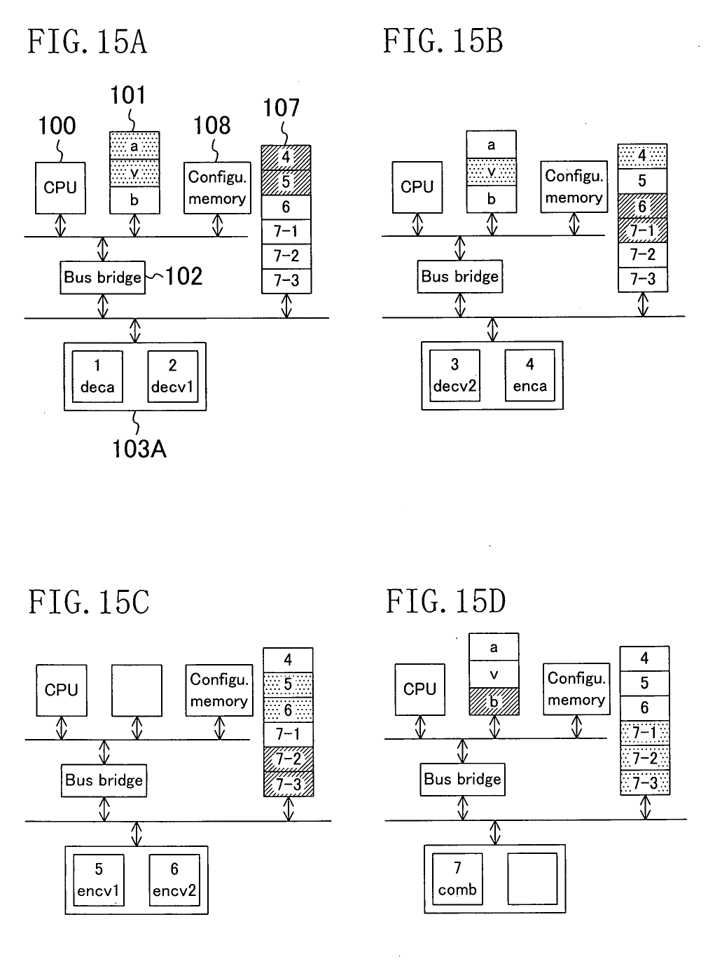

FIG. 15 shows an operation in the case where the two reconfigurable LSIs 103, 104 are replaced by one reconfigurable LSI 103A having integration twice as high as each of them in the computer system in FIG. 3. The CPU 100 references the size information stored in the configuration information storage memory 108 to assign two pieces of sub configuration data to the one reconfigurable LSI 103A. Whereby, data of which size is twice as large as that of each reconfigurable LSI 103, 104 in FIG. 3 is implemented to the reconfigurable LSI 103A.

Specifically, first, the reconfigurable LSI 103A is configured with the use of the sub configuration data with the numbers 1 and 2, namely, deca and decv1, as shown in FIG. 15(a). Then, the reconfigurable LSI 103A is configured with the use of the sub configuration data with the numbers 3 and 4, namely, decv2 and enca, as shown in FIG. 15(b), is configured with the use of the sub configuration data with the number 5 and 6, namely, encv1 and encv2, as shown in FIG. 15(c), and finally, is configured with the use of the sub configuration data with the number 7, namely comb, as shown in FIG. 15(d). The processing to be executed is the same as that shown in FIG. 14.

Of course, storage of the size information permits the computer system to cope flexibly with implementation of a highly integrated reconfigurable LSI and a less integrated reconfigurable LSI in combination.

The aforementioned dependence information and size information may not be included in the configuration information. For example, if variations in the number of to-be-attached reconfigurable modules are known, sequences of assignment of the sub configuration data may be set according to the variations. Specifically, the configuration information may include, in place of the dependence information, implementation sequence information indicating sequences of assignment of each sub configuration data which are determined according to the variations in the number of to-be-attached reconfigurable modules.

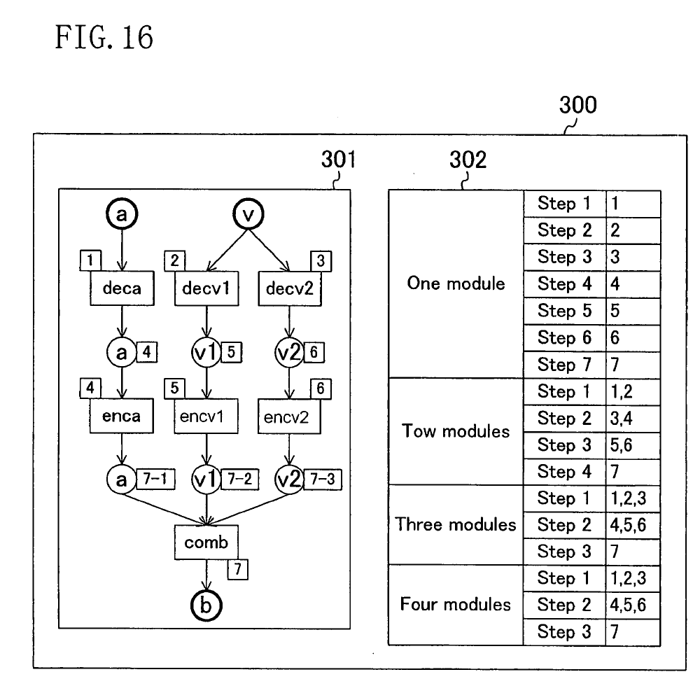

FIG. 16 shows one example of the configuration information including the implementation sequence information. In FIG. 16, configuration sequence determination information 300 includes internal structure information 301, which is the same as the internal structure information 401 in FIG. 9, and implementation sequence information 302. The implementation sequence information 302 indicates which sub configuration data are to be implemented in the steps in the respective cases with one to four modules. It is supposed herein that the number of sockets for reconfigurable LSIs in the computer system is four.

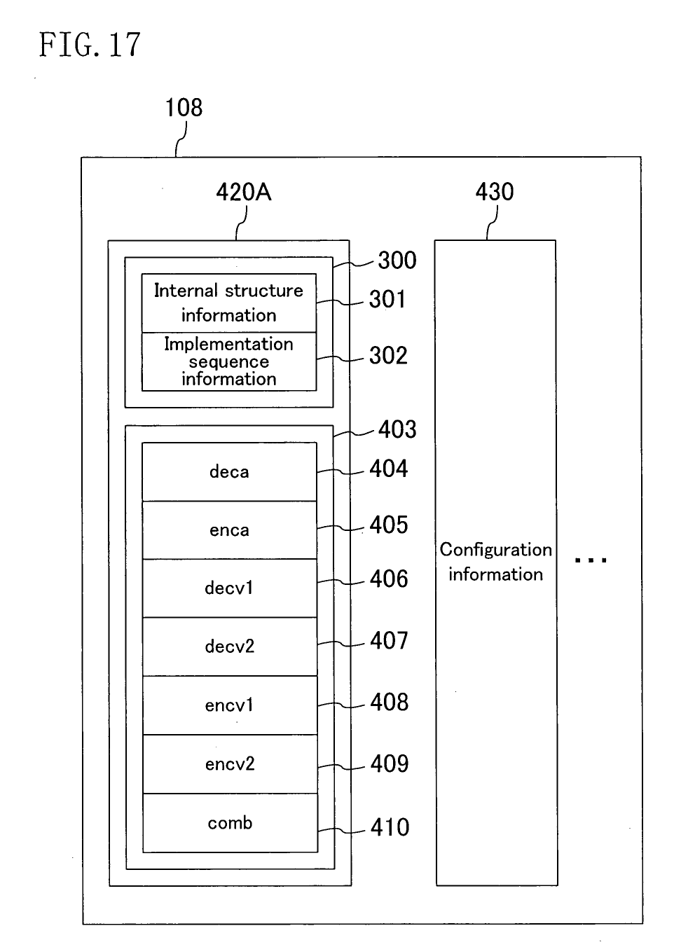

The same processing as that descried above can be executed by referencing the configuration information of FIG. 16, rather than the configuration information of FIG. 9, stored in the configuration information storage memory 108. FIG. 17 is a schematic diagram showing the state where the configuration information of FIG. 16 is stored in the configuration information storage memory 108. In FIG. 17, reference numeral 300 denotes the configuration sequence determination information including the internal structure information 301 and the implementation sequence information 302, and 403 denotes a sub configuration data module having plural pieces of sub configuration data 404 to 410. The configuration sequence determination information 300 and the sub configuration data module 403 compose configuration information 420A.

Further, in the example shown in FIG. 16, the implementation sequence information 302 shares the configuration sequence determination information 300 with the internal structure information 301 and indicates the sub configuration data to be implemented in the respective steps in each variation in the number of reconfigurable modules. Alternatively, mapping may be performed for each variation in the number of reconfigurable modules for directly providing configuration information to each reconfigurable module. Specifically, the configuration information may be generated for each variation in the number of to-be-attached reconfigurable modules. In this case, the configuration information storage memory 108 stores, according to the variations in the number of to-be-attached reconfigurable modules, plural pieces of configuration information including plural pieces of sub configuration data corresponding to functions into which the predetermined function is divided.

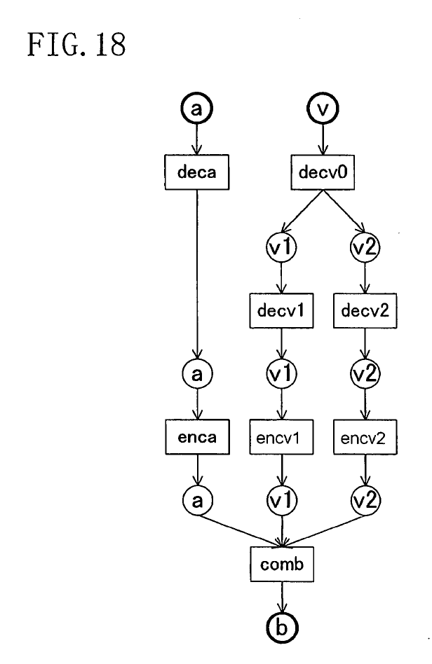

FIG. 18 shows another example of a processing result of the configuration information generating section 201 in the mapping system of FIG. 4. Though FIG. 7 shows the example where the algorithm is divided into two parts capable of being processed in parallel with each other, some video cannot be decoded completely in parallel. Accordingly, in FIG. 18, sub configuration data is generated as decv0 for parts to be processed in common (first processing in this case). In actual generation of configuration information, scheduling might have to be done so that parts connected in series and parts connected in parallel are optimized.

The architecture of the computer system so structured that reconfigurable modules are attachable is not limited to FIG. 1 and FIG. 3, and various architectures may be contemplated. Other examples of the architecture will be described below. In the drawings referred to in the following description, the same reference numerals as those in FIG. 1 and FIG. 3 are assigned to common constitutional elements for omitting the detailed description thereof.

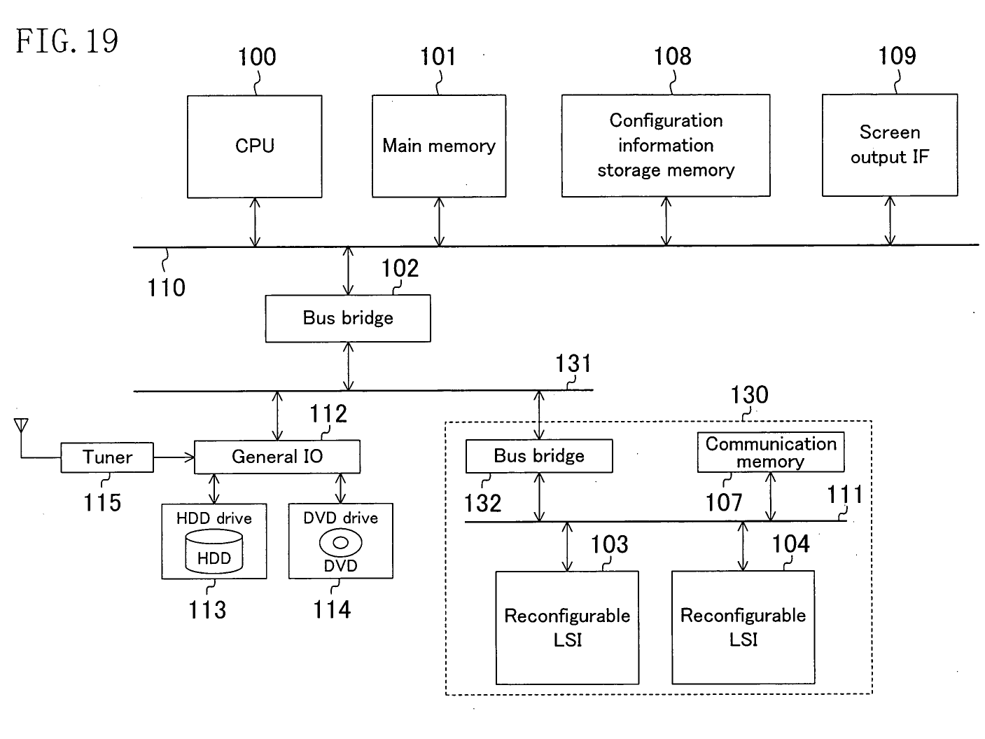

FIG. 19 shows a computer system including bus bridges in two stages in contemplation of implementation to a personal computer. A reconfigurable block 130 is connected to an IO bus 131. Reconfigurable LSIs 103, 104 are attachable to the reconfigurable block 130 and are capable of interchanging data with the IO bus 131 via a bus bridge 132.

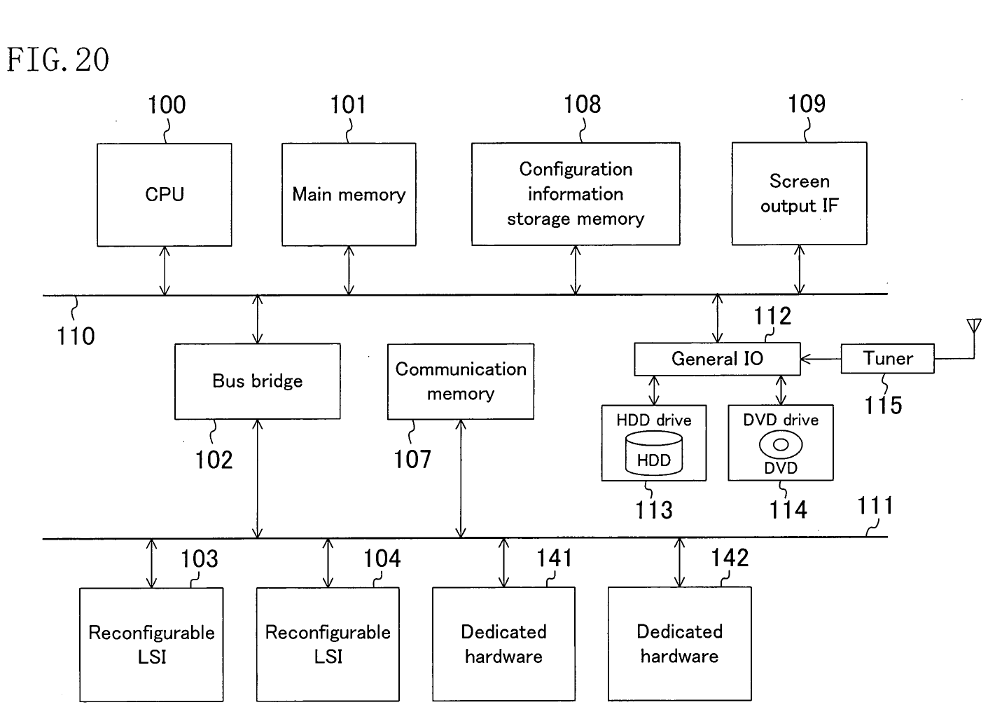

FIG. 20 shows a computer system to which dedicated hardware is connected in parallel with reconfigurable LSIs. Specifically, two pieces of dedicated hardware 141, 142 are connected to a communication bus 111 in parallel with reconfigurable LSIs 103, 104. When the specification is settled, execution of a function by dedicated hardware, which is initially executed by a reconfigurable LSI, is more advantageous in reduction in circuit size and power consumption. In this case, the configuration information is generated again for a function other than the function to be executed by the dedicated hardware.

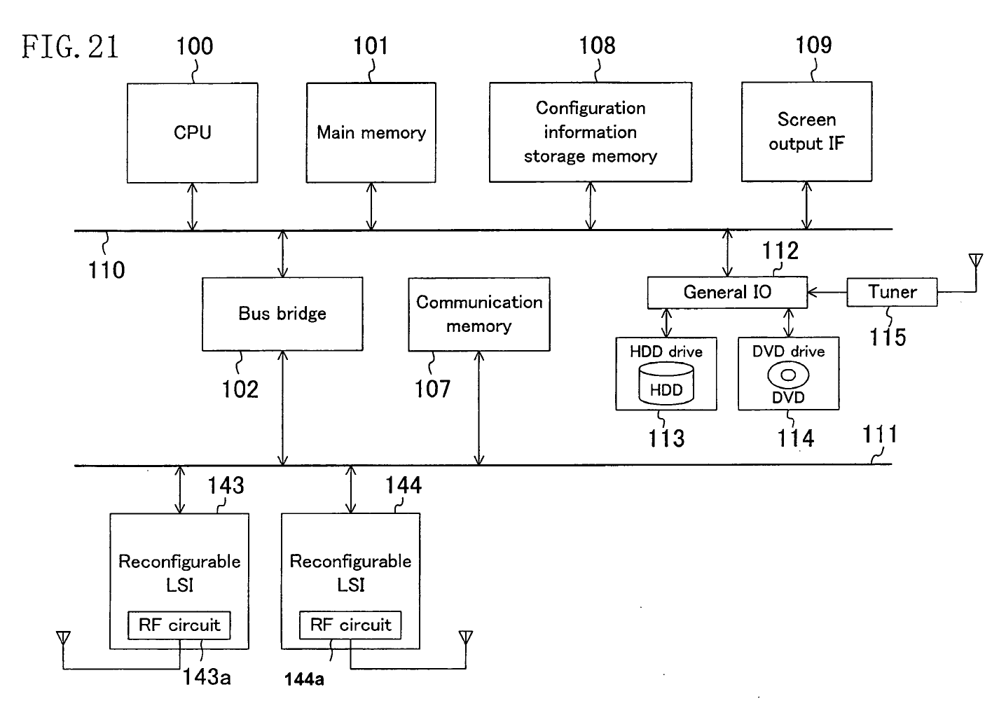

FIG. 21 shows a computer system to which reconfigurable LSIs each including an RF circuit are attached in contemplation of use for mobile phones. Reconfigurable LSIs 143, 144 include RF circuits 143a, 144a, respectively, which are capable of addressing three modes of wireless LAN, mobile phone, and Bluetooth. With either one of the reconfigurable LSIs, communication can be performed by only one mode of the wireless LAN, the mobile phone, and the Bluetooth. In the case where simultaneous communication by two modes is necessitated, two reconfigurable LSI must be implemented because a double processing amount is needed for the communication. When the RF circuits 143a, 144a capable of addressing the three modes are included in the two reconfigurable LSIs 143, 144, respectively, simultaneous communication by two modes is permitted.

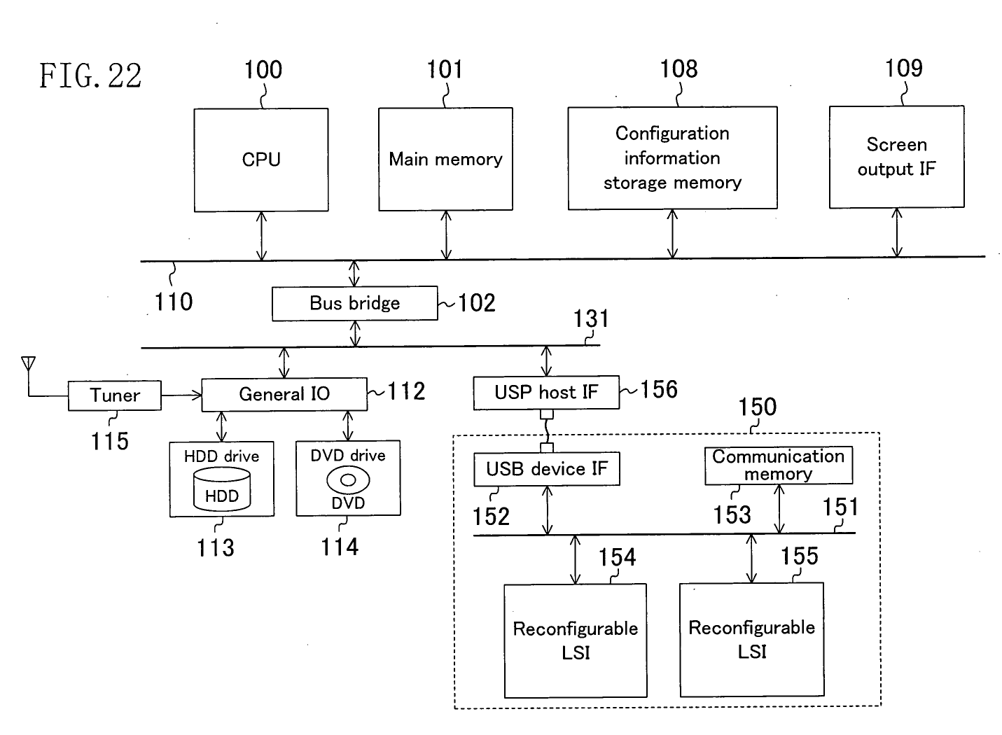

FIG. 22 shows a computer system to which a reconfigurable block is connected via a USB. In FIG. 22, a reconfigurable block 150 includes a communication bus 151, a USB device IF 152, a communication memory 153, and reconfigurable LSIs 154, 155 and is connected to the IO bus 131 via a USB host IF 156.

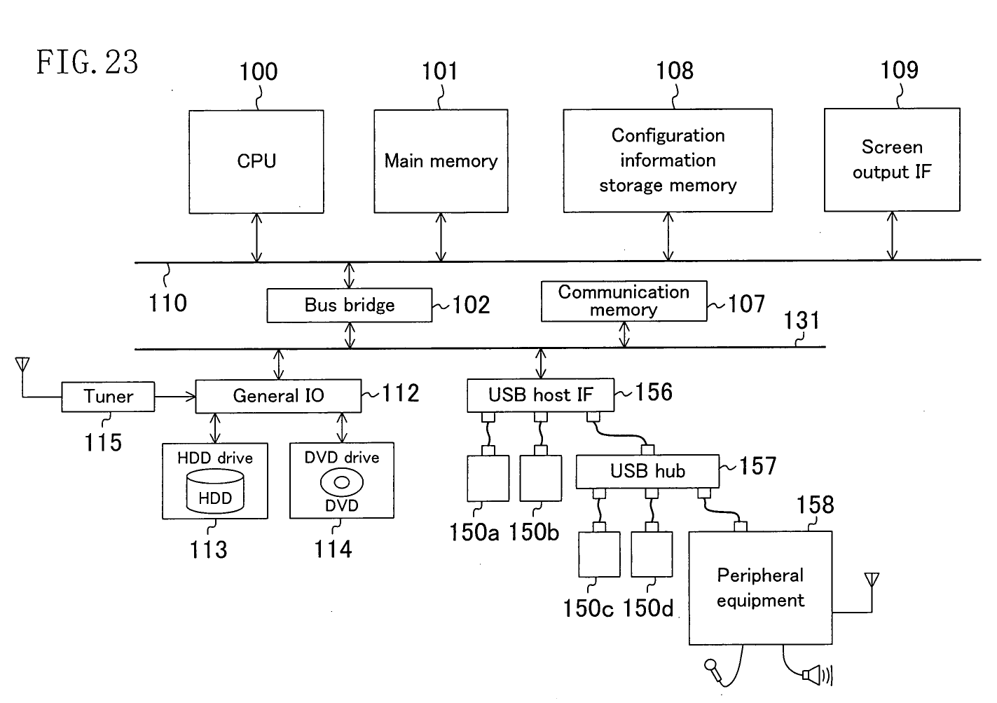

FIG. 23 shows a computer system to which reconfigurable blocks are hierarchically attached via a USB. In FIG. 23, reconfigurable blocks 150a, 150b are connected to a USB host IF 156 while reconfigurable blocks 150c, 150d are connected to a USB hub 157 connected to the USB host IF 156. Peripheral equipment 158 is also connected to the USB hub 157. The peripheral equipment 158 is a device including an antenna section, an audio input section, and an audio output section and has a function utilized to a wireless telephone, a mobile phone, or the like. With this computer system, local processing is enabled between, for example, the peripheral equipment 158 and the reconfigurable blocks 150c, 150d. The CPU 100 determines which configuration information should be mapped to which reconfigurable block. Accordingly, configuration information the most suitable to the respective connections of the reconfigurable blocks is mapped.

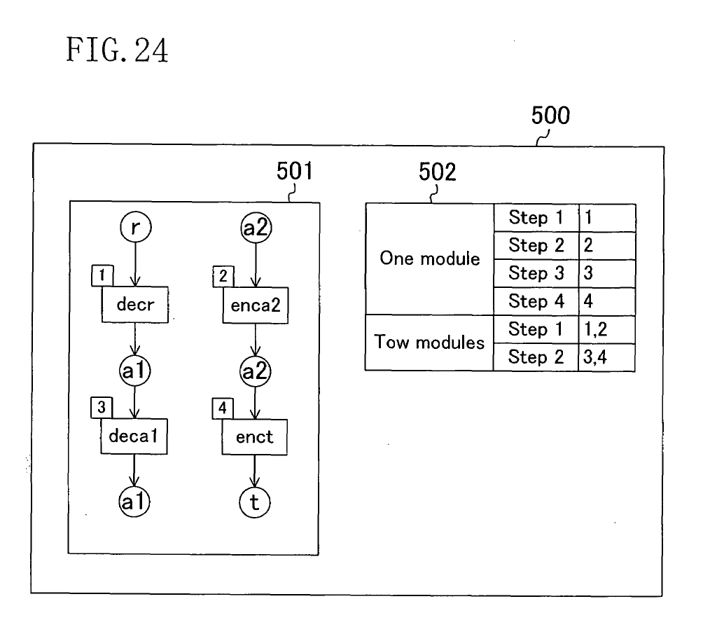

FIG. 24 is a conceptual diagram where configuration information taking extension by a USB hub into consideration is implemented. FIG. 24 shows configuration sequence determination information 500 on the reconfigurable blocks 150c, 150d connected to each other via the USB hub 157 in the system architecture of FIG. 23. The configuration sequence determination information 500 includes internal structure information 501 and implementation sequence information 502. In the internal structure information 501, a flow is indicated in which: received data (r) input from the antenna section of the peripheral equipment 158 is stream-coded (decr); the thus decoded audio data (a1) is output and audio-decoded (decal); and the thus decoded audio data (a1) is output. As well, another flow is indicated in which: audio data (a2) input from the audio input section of the peripheral equipment 158 is audio-encoded (enca2); the thus encoded data (a2) is output and stream-encoded (enct); and transmission data (t) is output.

The configuration sequence determination information 500 in FIG. 24 is stored in the configuration information storage memory 108 together with configuration information (the same as that of FIG. 16, for example) on the reconfigurable blocks 150a, 150b connected to each other via the USB host IF 156 in FIG. 23. The sub configuration data decr, decal, enca2, and enct are stored as well.

The reconfigurable blocks 150c, 150d are used for processing that the peripheral equipment 158 connected to the USB hub 157 deals with. On the other hand, the reconfigurable blocks 150a, 150b are used for processing a video input from the general IO 112 connected to the bus 131. Accordingly, the reconfigurable blocks 150c, 150d and the reconfigurable blocks 150a, 150b are configured separately, and the respective pieces of configuration information thereof are stored separately.

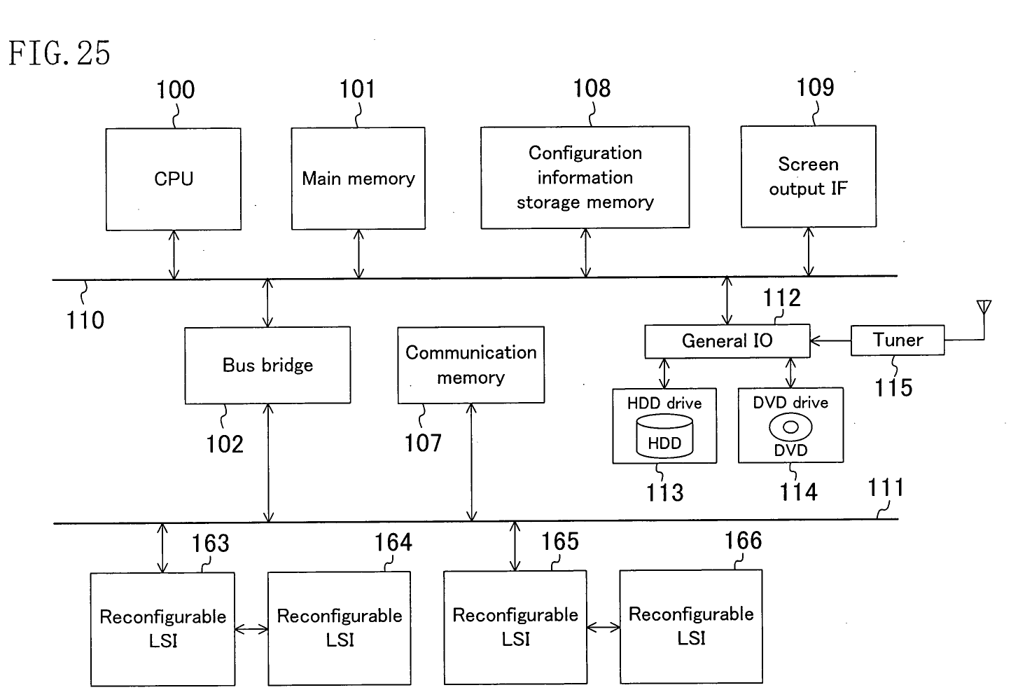

FIG. 25 shows a computer system to which reconfigurable LSIs are attached without being connected to a bus. In FIG. 25, a reconfigurable LSI 164 is connected directly to a reconfigurable LSI 163 with no communication bus 111 interposed, and a reconfigurable LSI 166 is connected directly to a reconfigurable LSI 165 with no communication bus 111 interposed. This architecture is effective in the case, for example, where the reconfigurable LSI 164 communicates with only the reconfigurable LSI 163 with no communication with the reconfigurable LSIs 165, 166 needed.

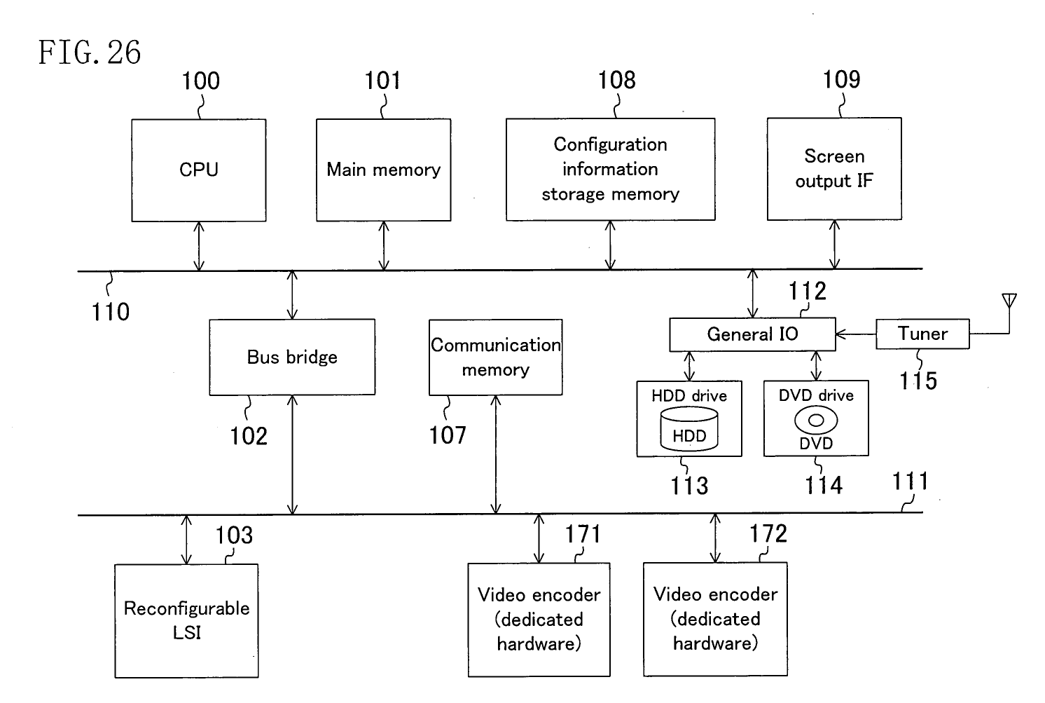

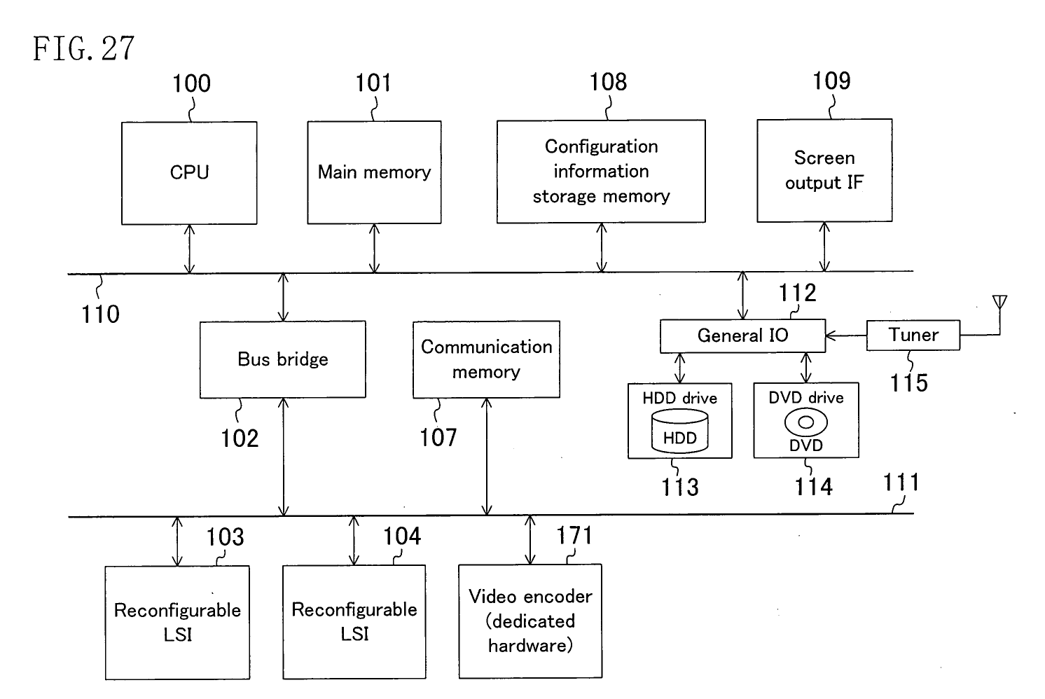

FIG. 26 shows an architecture where a video encoder 171 and a video decoder 172 are attached as dedicated LSIs in addition to a reconfigurable LSI. As well, FIG. 27 shows an architecture where a video encoder 171 is attached as a dedicated LSI in addition to two reconfigurable LSIs.

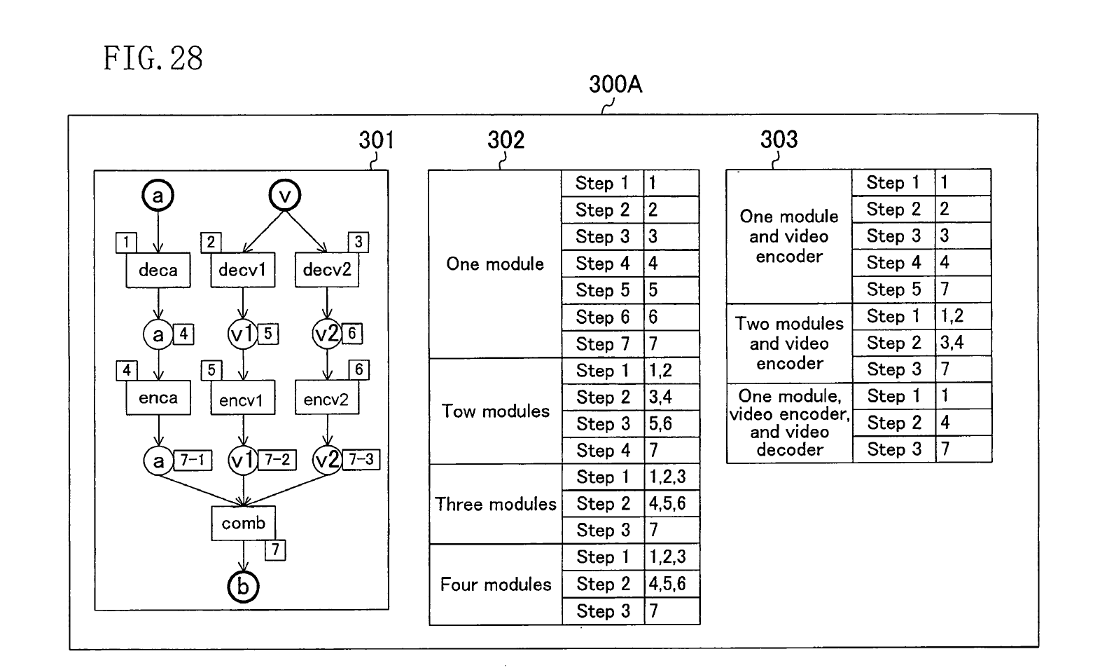

FIG. 28 is a conceptual drawing where configuration information generated is implemented with a fact taken into consideration that a video encoder or a video decoder will be attached as a dedicated LSI. The configuration sequence determination information 300 shown in FIG. 16 includes the implementation sequence information 302 that sets each processing shown in FIG. 7 to be executed step by step by only the reconfigurable LSI(s). In contrast, configuration sequence determination information 300A shown in FIG. 28 includes, in addition to the implementation sequence information 302, implementation sequence information 303 which takes it into consideration that when a video encoder or a video decoder is attached as a dedicated LSI, the attached one executes video encoding or video decoding.

In the internal structure information 301, the video decoding decv and the video encoding encv are divided into two sub configuration data decv1 and dcv2 and two sub configuration data encv1 and encv2, respectively. Wherein, the dedicated LSI is provided on the assumption that each of the above processing can be completed until a reconfiguration LSI completes processing by one step.

In general, the dedicated LSI, which is designed for executing specific processing at high speed, can complete the processing in a period of time shorter than a reconfigurable LSI. In the computer systems having the architectures shown in FIG. 26 and FIG. 27, the video encoder 171 and the video decoder 172 can execute thoroughly video encoding decv divided into two and video decoding encv divided into two, respectively, within a time period when the reconfigurable LSI executes a single unit of processing, such as audio decoding, audio encoding, or the like.

### INDUSTRIAL APPLICABILITY

The present invention can increase the amount of processing to be executed and can cope with a new algorithm, such as compression/expansion of a video after purchase by attaching a reconfigurable module by a user, and therefore is suitable for utilization to video recording devices, such as a DVR and the like, for example.

Further, in the present invention, in the case where a reconfigurable module is developed of which processing ability is further increased by enhancing the operation frequency, increasing the number of transistors, or the like, replacement by the reconfigurable module attains processing with a less number of reconfigurable modules. Hence, power consumption in the same processing is reduced, and accordingly, the present invention is suitable to utilization to mobile phones, for example.

In addition, attachment of a reconfigurable module results in easy extension of the processing ability of a whole system, and accordingly, the present invention is suitable for workstations for addressing multimedia processing.

1. A computer system, comprising:
a CPU; and
a configuration information storage section which stores configuration information for allowing a reconfigurable module to execute a predetermined function,
wherein the computer system is so structured that one or more reconfigurable modules are attachable, and
the CPU configures an attached reconfigurable module according to number of the attached reconfigurable module by referencing the configuration information stored in the configuration information storage section.

2. The computer system of claim 1, further comprising:
a communication bus; and
a plurality of joint parts which are connected to the communication bus and to which the reconfigurable modules are attachable,
wherein the CUP is capable of communicating via the communication bus with any reconfigurable module attached to any of the joint parts.

3. The computer system of claim 1,
wherein when the number of the attached reconfigurable module is changed, the CPU configures attached reconfigurable modules according to the number thereof after change by referencing the configuration information.

4. The computer system of claim 1,
wherein the configuration information includes plural pieces of sub configuration data corresponding to divided functions into which the predetermined function is divided, and
the CPU executes configuration by assigning the plural pieces of sub configuration data to the attached reconfigurable modules.

5. The computer system of claim 4,
wherein the configuration information includes configuration sequence determination information for determining assignment of the plural pieces of sub configuration data, and
the configuration sequence determination information includes internal structure information indicating a relationship between the plural pieces of sub configuration data and input/output data.

6. The computer system of claim 5,
wherein the configuration sequence determination information includes dependence information indicating dependence between the plural pieces of sub configuration data.

7. The computer system of claim 5,
wherein the configuration sequence determination information includes implementation sequence information indicating sequences of assignment of the plural pieces of sub configuration data which are determined according to variations in the number of to-be-attached reconfigurable modules.

8. The computer system of claim 4,
wherein the configuration information further includes information on each size of the plural pieces of sub configuration data.

9. The computer system of claim 4,
wherein each size of the plural pieces of sub configuration data is set within a predetermined size.

10. The computer system of claim 4,
wherein the configuration information storage section includes plural pieces of the configuration information, and
the plural pieces of the configuration information are generated according to variations in the number of to-be-attached reconfigurable modules.

11. A data structure for representing configuration information for allowing a reconfigurable module to execute a predetermined function, comprising:
plural pieces of sub configuration data respectively corresponding to divided functions into which the predetermined function is divided; and
internal structure information indicating a relationship between the plural pieces of sub configuration data and input/output data.

12. The data structure of claim 11, further comprising:
dependence information indicating dependence between the plural pieces of sub configuration data.

13. The data structure of claim 11, further comprising:
implementation sequence information indicating sequences of assignment of the plural pieces of sub configuration data which are determined according to variations in the number of reconfigurable modules.

14. A data structure for representing configuration information for allowing a reconfigurable module to execute a predetermined function, comprising:
plural pieces of configuration information corresponding to variations in number of reconfigurable modules,
wherein each piece of configuration information includes plural pieces of sub configuration data respectively corresponding to divided functions into which the predetermined function is divided.

15. A mapping system for generating configuration information for allowing a reconfigurable module to execute a predetermined function, comprising:
an algorithm analyzing section which performs algorithm analysis on the predetermined function to generate a graph expressing a relationship between processing and input/output data; and
a configuration information generating section which generates, by dividing each processing in the graph with a predetermined size set as an upper limit, plural pieces of sub configuration data respectively corresponding to divided functions into which the predetermined function is divided and internal structure information indicating a relationship between the plural pieces of sub configuration data and input/output data.

16. A mapping method for generating configuration information for allowing a reconfigurable module to execute a predetermined function, comprising the steps of:
an algorithm analyzing step of performing algorithm analysis on the predetermined function to generate a graph expressing a relationship between processing and input/output data; and
a configuration information generating step of generating, by dividing each processing in the graph with a predetermined size set as an upper limit, plural pieces of sub configuration data respectively corresponding to divided functions into which the predetermined function is divided and internal structure information indicating a relationship between the plural pieces of sub configuration data and input/output data.
